(19) United States
(12) Patent Application Publication
(10) Pub. No.: US 2010/0157253 A1
(43) Pub. Date: Jun. 24, 2010

(54) METHOD AND SYSTEM OF SCANNING LASER BEAM IMAGE PROJECTION

(75) Inventor: Adrianus J.S. De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,279

(22) PCT Filed: Jun. 26, 2006
(86) PCT No.: PCT/IB06/52091

§ 371 Date: Dec. 20, 2007

Related U.S. Application Data
(60) Provisional application No. 60/695,246, filed on Jun. 29, 2005.

(51) Int. Cl. G03B 21/28

(52) U.S. Cl. 353/69

(57) ABSTRACT

A projector (300) includes a laser (310) that generates a light beam, a modulator (320) that modulates the light beam with image data, a scanner (340) that scans the light beam to display an image, and a diverger (350) (e.g., a lens) that diverges the light beam to increase its beamwidth. The beamwidth of the light beam may be increased such that it is approximately the same as a width of a pixel of the image. A three-color projector (300) includes second and third lasers (312, 314) that generate second and third light beams, second and third divergers (352, 354) that diverge the second and third light beams, to increase the beamwidths thereof, and means for combining (330) the three light beams.

This invention pertains to the field of image projection, and more particularly, to a method and system of scanning laser beam image projection.

As technology develops, scanning laser beam image projectors are increasingly becoming miniaturized and therefore, portable. At the same time, these scanning laser beam image projectors are also becoming less expensive. As a result of these trends, it is expected that there will be a proliferation in both the number of scanning laser beam image projectors, and the usage of these devices. For example, small scanning laser beam image projectors may be incorporated in, or integrated with, portable data processing and/or communication devices, such as mobile telephones, personal digital assistants (PDAs), portable MP3 music players, combination communication/data processing devices, etc.

Safety is a concern accompanying the proliferation of such devices. In particular, stray laser light that impinges on someone's eye has the potential to damage there vision. As these small, portable, scanning laser beam image projectors become more commonplace, the occurrences of laser light unintentionally being directed into someone's eye will naturally increase. So there is a need to provide methods and devices for reducing the likelihood of inadvertently exposing people to damaging laser light.

U.S. Pat. No. 6,002,505 and European Patent Application EP1513008 each describe a scanning laser beam image projector that includes sensors for detecting when a person enters, or is about to enter, the optical path between a light source and a projection screen. In the system disclosed in U.S. Pat. No. 6,002,505, when a person enters, or is about to enter, the optical path between a laser projector and a display screen, current supply to the laser is disconnected, or the laser light is otherwise blanked when it scans across an area where a person is detected. In the system disclosed in European Patent Application EP1513008, when a person enters, or is about to enter, the optical path between a light source and a projection screen, the intensity of the light beam is reduced or cut-off.

However, there are some disadvantages to these arrangements. For one thing, they require additional sensors and other components which drive up the cost and increase the size of the projector. Furthermore, these solutions are better suited to fixed installations, than to a portable operating environment. Also, the systems are prone to be set off by false alarms, such as inanimate objects which may enter the sensing area.

Accordingly, it would be desirable to provide scanning laser beam image projector which reduces the likelihood of inadvertently exposing people to damaging levels of laser light. It would also be desirable to provide a method of projecting an image using a laser light source that reduces the likelihood of inadvertently exposing people to damaging laser light. The present invention is directed to addressing one or more of the preceding concerns.

In one aspect of the invention, an image projection device comprises: first, second, and third lasers adapted to generate first through third light beams, respectively; a modulator adapted to modulate the first through third light beams with image data; a scanner adapted to scan the first through third light beams onto a display surface to display an image; and at least one lens adapted to diverge the first through third light beams, such that a beamwidth of each diverged light beam is increased so as to be approximately the same as a width of a pixel of the image.

In another aspect of the invention, a method of displaying an image comprises:

generating a first laser light beam; modulating the first laser light beam with image data; scanning the first laser light beam onto a display surface to display an image; and diverging the first laser light beam, such that a beamwidth of the diverged first laser light beam is approximately the same as a width of a pixel of the image.

In yet another aspect of the invention, an image projection device comprises: a first laser adapted to generate a first light beam; a modulator adapted to modulate the first light beam with image data; a scanner adapted to scan the first light beam to display an image; and a first diverger adapted to diverge the first light beam, such that a beamwidth of the first light beam is increased.

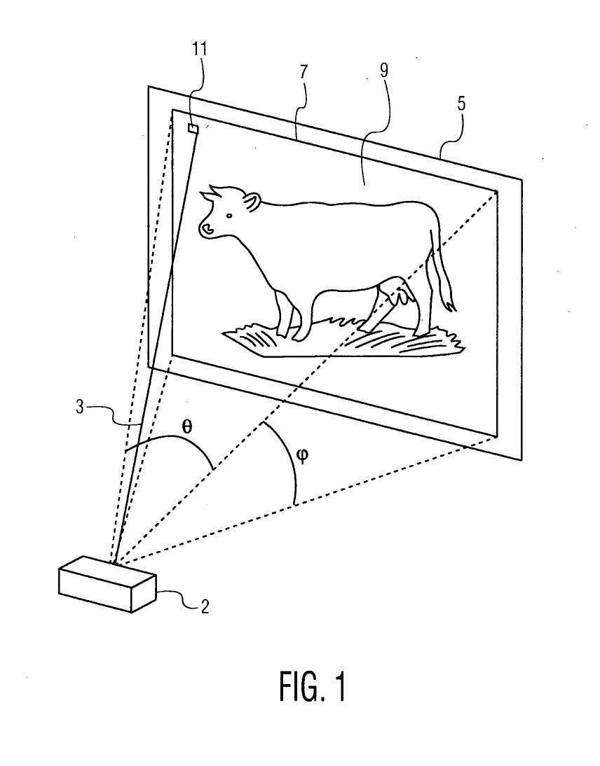

FIG. 1 illustrates the scanning projection of a laser light beam on a display surface;

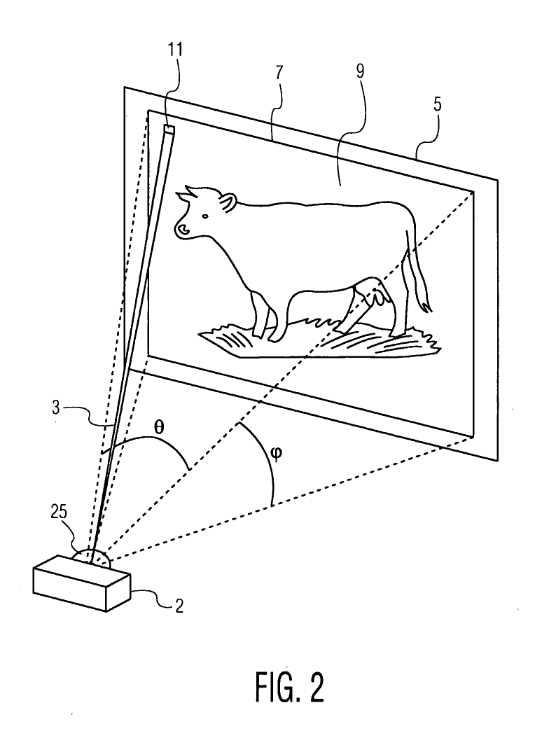

FIG. 2 illustrates the scanning projection of a laser light beam on a display surface where the light beam is diverged;

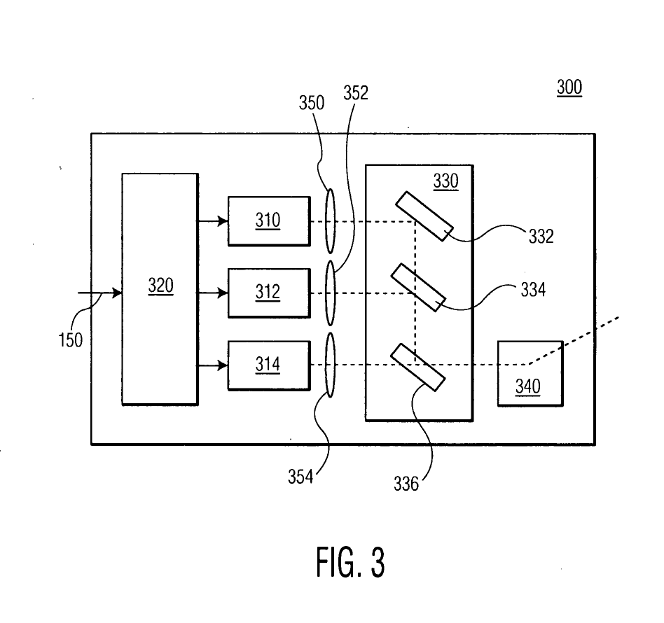

FIG. 3 is a functional block diagram of one embodiment of a scanning laser beam image projector.

FIG. 1 illustrates the scanning projection of a laser light beam 3 on a display surface 5. As shown in FIG. 1, a laser light source 2 scans the laser light beam 3 across a raster area 7 on the display surface 5 to produce an image 9. The laser light beam 3 scans across a horizontal angle θ and a vertical angle φ to cover the raster area 7. The image 9 comprises a plurality of pixels 11 that set the resolution of the image 9. For example, one standard high resolution image format may include 480 pixels 11 per horizontal line, and 360 lines of pixels 11 per image 9, which is referred to as an 480×360 image format. Other display formats having greater resolution, such as 640×480, 800×600, etc are also possible, although the lower resolution formats may be more common for low-cost portable scanning laser beam image projectors that are included in mobile telephones, PDAs, etc.

As used herein, a pixel is defined as the smallest resolvable area of an image, either on a display screen or stored in memory. Each pixel in a monochrome image has its own brightness, for example from 0 for black to the maximum value (e.g. 255 for an eight-bit pixel) for white. In a color image, each pixel has its own brightness and color, usually represented as a triple of red, green and blue (RGB) intensities.

One can represent the angular width, ω, of a pixel 11 as being θ/H, where H is the number of pixels per line. Similarly, one can represent the angular height, ν, of a pixel 11 as being φ/L where L is the number of lines per image. Once a distance d is established between laser light source 2 and the display surface 5, once can then determine the width, W of each pixel 11 on the display surface 5 as:

W=2d*tan(θ/2H). (1)

Similarly, one finds that the height, H, of each pixel 11 on the display surface 5 is:

H=2d*tan(φ/2L). (2)

To illustrate, consider an example where H=480, L=360, d=1 meter, θ=60°, and φ=45°. In that case, one finds that the size of the image 9 on the display surface 5 is about 1.05 m×0.79 m, and W=H≈2.2 mm.

Meanwhile, the angular beamwidth (that is, the 1/e beamwidth) of a typical laser light beam might be in the range of 0.5 mrad=0.02865 degrees, such that at a distance, d, of one meter, the beamwidth would be 0.5 mm.

So, in this case it is seen that the beamwidth of the laser light beam 3 is less than a size of a pixel 11 of an image 9 displayed on the display surface 5. Therefore, the optical energy density of the laser light beam 3 is greater than is necessary to reproduce the image 9 with its full resolution. Accordingly, the optical safety of the laser light beam 3 can be enhanced, without any loss in image resolution, by increasing the beamwidth of the laser light beam 3. Beneficially, the optical safety can be optimized with respect to the desired image resolution when the beamwidth of the laser light beam 3 is made to be approximately (+/−10%, and preferably +/−5%) the same as a width of a pixel 11.

FIG. 2 illustrates the scanning projection of a laser light beam 3 on a display surface 5 where the laser light beam 3 is diverged by a lens 25. Beneficially, the lens 25 diverges the laser light beam 3 such that the beamwidth in the image plane at the display surface 5 is approximately (+/−10%, and preferably +/−5%) the same size of width of a pixel 11 of a displayed image 9. Accordingly, the density of the optical energy of the laser light beam 3 is reduced, and is even proportionately more reduced as the laser light beam 3 proceeds further and further away from the laser light source 2. Accordingly, a lower light density impinges on the retina of a human eye if the beam should go astray and inadvertently be directed onto a human pupil. This effect is especially beneficial once the beamwidth becomes larger that the size of a human pupil so that a portion of the light does not harm the eye.

FIG. 3 is a functional block diagram of one embodiment of a scanning laser beam image projector 300. Scanning laser beam image projector 300 includes first through third laser light sources 310, 312, and 314, modulator 320, combining means 330, scanner 340, and first through third divergers 350, 352, and 354.

Beneficially, first through third laser light sources 310, 312, and 314 comprise a red light source, a blue light source, and a green light source. However, other color arrangements are possible, and more than three laser light sources for more than three colors (e.g., red, blue, green-1 and green-2) can be used.

Beneficially, modulator 320 controls a current supplied to laser light sources 310, 312, and 314 to modulate the light intensity produced therefrom in accordance with the image to be displayed. Other modulation arrangements may be employed.

Beneficially, combining means 330 includes a “regular” mirror 332, and first and second dichroic mirrors 334 and 336. Other arrangements utilizing optical couplers such as waveguides are also possible.

Beneficially, scanner 340 comprises a scanning (deflecting) mirror.

Beneficially, each of first through third divergers 350, 352, and 354 comprises an optical lens adapted to diverge the beamwidth of the laser beams from respective laser light sources 310, 312, and 314. The lenses may be simple convex lenses, or may include more complicated structures, such as conical lenses. Diffusers, apertures, or combinations of all of the above may be employed in first through third divergers 350, 352, and 354 instead of the single optical lenses.

Operation of the scanning laser beam image projector 300 will now be explained. Modulator 320 receives a video signal 150 comprising image data, and modulates the light from first through third laser light sources 310, 312, and 314 in accordance with the image data. The light from each of first through third laser light sources 310, 312, and 314 is passed through a corresponding one of first through third divergers 350, 352, and 354. First through third divergers 350, 352, and 354 each increase the angular beamwidth of the corresponding laser light beam passing therethrough. Beneficially, first through third divergers 350, 352, and 354 each diverge a corresponding laser light beam such that its beamwidth in the image plane, at a display surface where the image is to be projected, is approximately (+/−10%, and preferably +/−5%) the same size as the width of a pixel of a displayed image.

Combining means 300 combines the laser light beams from first through third laser light sources 310, 312, and 314 and passes the combined light beam to scanner 340. For example, where combining means 330 includes mirror 332 and first and second dichroic mirrors 334 and 336, the first laser light beam from first laser light source 310 passes through first diverger 350 and is reflected by mirror 332 to first dichroic mirror 334. First dichroic mirror 324 is adapted to pass the first laser light beam, and to reflect the second laser light beam from second laser light source 312, thereby combining the first and second laser light beams and directing the combined first and second laser light beams to second dichroic mirror 326. Second dichroic mirror 326 is adapted to pass the third laser light beam from third laser light source 314 therethrough, and to reflect the combined first and second laser light beams, thereby combining the first, second, and third laser light beams and directing the combined first, second and third laser light beams to scanner 340.

Accordingly, the density of the optical energy of the laser light beams is reduced by first through third divergers 350, 352, and 354 divergers, and is even proportionately more reduced as the laser light beams proceed further and further away from scanning laser beam image projector 300. Due to this lower density, a lower light density impinges on the retina of a human eye if the beam should go astray and inadvertently be directed onto a human pupil. This effect is especially beneficial once the beamwidth becomes larger than the size of a human pupil

Optionally, in a different embodiment, only one laser light source 310 and one diverger 350 may be used to display a monochrome image. Such an arrangement might be used when displaying text, such as, for example, browsing a list of MP3 files when the scanning laser beam image projector is incorporated in, or integrated with, a portable MP3 music player.

Other variations are possible. For example, instead of using three separate divergers, a single diverger 350 (e.g., a single lens) may be provided in an optical path after the first, second, and third laser light beams are combined, to increase the beamwidth of the combined first, second, and third laser light beams.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. An image projection device (300), comprising:
first (310), second (312), and third (314) lasers adapted to generate first through third light beams, respectively;
a modulator (320) adapted to modulate the first through third light beams with image data;
a scanner (340) adapted to scan the first through third light beams onto a display surface (5) to display an image; and
at least one lens (350) adapted to diverge the first through third light beams, such that a beamwidth of each diverged light beam is increased so as to be approximately the same as a width of a pixel of the image.

2. The device (300) of claim 1, further comprising combining means (330) for combining the first, second, and third light beams.

3. The device (300) of claim 2, wherein the combining means (330) includes two dichroic mirrors (334, 336).

4. The device (300) of claim 2, wherein the at least one lens (350) comprises three lenses (350, 352, 354), each of the three lenses (350, 352, 354) being adapted to diverge a corresponding one of the first through third light beams from a corresponding one of the first, second, and third lasers (310, 312, 314).

5. The device (300) of claim 4, wherein each of the three lenses (350, 352, 354) is disposed in an optical path between the corresponding one of the first, second, and third lasers (310, 312, 314) and the combining means (330).

6. The device of claim 1, wherein the at least one lens (350) comprises three lenses (350, 352, 354), each of the three lenses (350, 352, 354) being adapted to diverge a corresponding one of the first through third light beams from a corresponding one of the first, second, and third lasers (310, 312, 314).

7. A method of displaying an image, comprising:
generating a first laser light beam;
modulating the first laser light beam with image data;
scanning the first laser light beam onto a display surface to display an image; and
diverging the first laser light beam, such that a beamwidth of the diverged first laser light beam is approximately the same as a width of a pixel of the image.

8. The method of claim 7, further comprising:
generating second and third laser light beams;
modulating the second and third laser light beams with the image data;
scanning the second and third laser light beams onto the display surface to display the image; and
diverging the second and third laser light beams, such that a beamwidth of each diverged laser light beam is approximately the same as a width of a pixel of the image.

9. The method of claim 8, further comprising combining the first, second, and third laser light beams.

10. The method of claim 9, where diverging the first, second and third laser light beams comprises passing the first, second and third laser light beams through first through third lenses, respectively.

11. The method of claim 9, wherein the steps of diverging the first, second, and third laser light beams occurs prior to combining the first, second, and third laser light beams.

12. The method of claim 7, wherein diverging the first laser light beam comprises passing the first laser light beam through a lens.

13. An image projection device (300), comprising:
a first laser (310) adapted to generate a first light beam;
a modulator (320) adapted to modulate the first light beam with image data;
a scanner (340) adapted to scan the first light beam to display an image; and
a first diverger (350) adapted to diverge the first light beam, such that a beamwidth of the first light beam is increased.

14. The device (300) of claim 13, wherein the first diverger (350) is adapted to increase the beamwidth of the first light beam such that it is approximately the same as a width of a pixel of the image.

15. The device (300) of claim 13, wherein the diverger (350) comprises a lens.

16. The device (300) of claim 13, further comprising:
second (312) and third (314) lasers adapted to generate second and third light beams; and
second (352) and third (354) divergers adapted to diverge the second and third light beams, respectively, such that a beamwidth of each of the second and third light beams is increased,
wherein the modulator (320) is adapted to modulate the second and third light beams with the image data, and
wherein the scanner (340) is adapted to scan the second and third light beams onto the display surface to display the image.

17. The device (300) of claim 16, wherein the first (350), second (352) and third (354) divergeis are adapted to increase the beamwidth of the first, second, and third light beams, respectively such that a beamwdith of each of the first, second and third light beams is approximately the same as a width of a pixel of the image.

18. The device (300) of claim 16, wherein each of the first (350), second (352) and third (354) divergers comprises a lens.

19. The device of claim 18, further comprising combining means (330) for combining the first, second, and third light beams, the combiner including two dichroic mirrors (334, 336).
